(19) United States
(12) Patent Application Publication
(10) Pub. No.: US 2019/0126386 A1
(43) Pub. Date: May 2, 2019

(54) WELDING METHOD AND PART MADE BY THE WELDING METHOD

(71) Applicant: GM GLOBAL TECHNOLOGY OPERATIONS LLC, DETROIT, MI (US)

(72) Inventors: Huaxin Li, Rochester Hills, MI (US); Daniel J Wilson, Linden, MI (US)

(21) Appl. No.: 15/797,147

(22) Filed: Oct. 30, 2017

(51) Int. Cl. B23K 20/227; B23K 20/12; C23C 30/00

(52) U.S. Cl. CPC B23K 20/2275; C23C 2/04; C23C 30/00; B23K 20/12

(57) ABSTRACT

A method for welding a first component to a second component includes providing a first component of a first alloy and having coating of a second alloy on a face of the first component, and solid state welding a second component of a third alloy to the coating of the first component. The second alloy includes only non-ferrous compounds.

### FIELD

The present disclosure relates to a welding method and part made by the welding method.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

In a typical motor vehicle, certain components are welded together. Some welds involve components made of different alloys. For example, a lighter alloy such as aluminum or magnesium may be joined with a heavier alloy such as steel. Because of the physical and metallurgical property differences between these alloys, the joint strength may not be strong enough for certain applications. Specifically, brittle intermetallic compound formation and high residual stresses in the weld joint resulting from the use of alloys with different properties may limit the joint strength.

These limitations may prevent and/or reduce the ability to reduce the mass of automotive components which, in turn, may prevent and/or reduce the fuel efficiency, economy, performance, battery life, range and other important characteristics of an automobile.

### SUMMARY

In an exemplary aspect, a method for welding a first component to a second component includes providing a first component of a first alloy and having coating of a second alloy on a face of the first component, and solid state welding a second component of a third alloy to the coating of the first component. The second alloy includes only non-ferrous compounds.

In another exemplary aspect, the first alloy is a steel alloy.

In another exemplary aspect, the third alloy is an aluminum alloy.

In another exemplary aspect, the third alloy is a magnesium alloy.

In another exemplary aspect, the solid state welding is friction welding.

In another exemplary aspect, the method further includes applying the coating to the first component.

In another exemplary aspect, the step of coating includes at least one of a plating, hot dipping, vapor deposition, physical vapor deposition, and chemical vapor deposition.

In another exemplary aspect, the second alloy is one of a nickel based alloy and a copper based alloy.

In another exemplary aspect, the thickness of the coating is between about 10 to 200 micrometers.

In another exemplary aspect, a part for a vehicle propulsion system is produced by a process including the steps of providing a first component of a first alloy and having coating of a second alloy on a face of the first component, and solid state welding a second component of a third alloy to the coating of the first component. The second alloy includes only non-ferrous compounds.

In this manner, a component may be provided having a significantly reduced mass while ensuring a strong bond between dissimilar metals, such as, for example, steel and aluminum, by reducing and/or eliminating the potential for brittle intermetallic compounds forming at the interface. This is especially valuable in an automotive part, such as in a vehicle propulsion system, where a reduction of mass may provide significant improvements in fuel economy, efficiency, performance, extended range, increased battery life and the like.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1A is a schematic diagram of a rotational friction welding system;

FIG. 1B is side view of two exemplary components welded together with the system shown in FIG. 1A; and

FIG. 2 illustrates an exemplary interface between a steel component and an aluminum component created with a friction welding system.

In the drawings, reference numbers may be reused to identify similar and/or identical elements.

### DETAILED DESCRIPTION

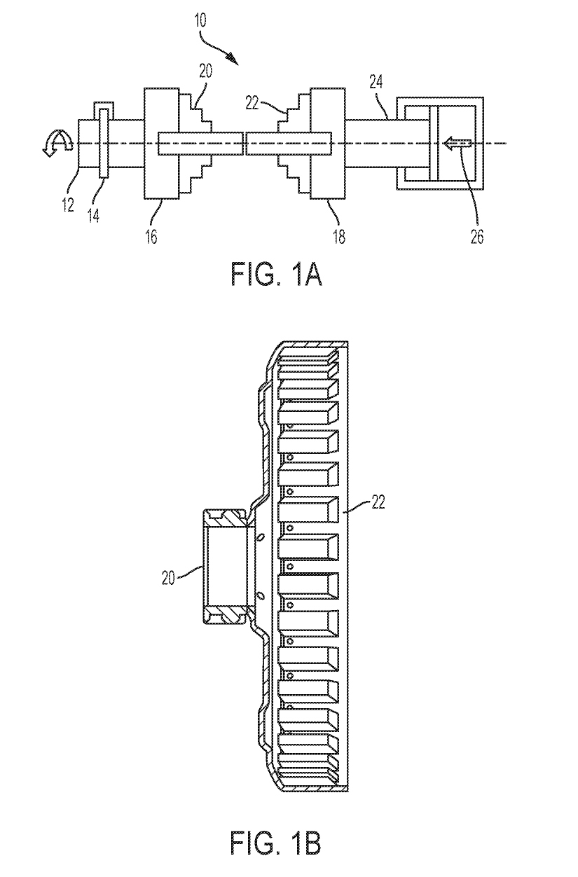

Referring now to the drawings, a rotational friction weld system is shown in FIG. 1A at 10. The system 10 includes a motor 12 that rotates a rotating chuck 16. A brake 14 is employed to control the rotational speed of the rotating chuck 16. The system 10 further includes a non-rotating chuck 18 coupled to a hydraulic cylinder 24.

When the system 10 is in use, the rotating chuck 16 holds a first work piece or component 20 and the non-rotating chuck 18 holds a second work piece or component 22. The first and second work pieces are made of dissimilar materials. For example, in certain arrangements the first work piece 20 may be a steel gear and the second work piece 22 may be an aluminum clutch shell.

The motor 12 spins the rotating chuck 16 and hence the first work piece 20 at a high rate of rotation. When the first work piece 20 is spinning at the proper speed, the hydraulic cylinder 24 moves the non-rotating chuck 18 and hence the second work piece 22 towards the first work piece 20 in the direction of the arrow 26. Accordingly, the two work pieces 20 and 22 are forced together under pressure to form a frictional weld that joins the two work pieces together as shown in FIG. 1B. The spinning is stopped to allow the weld to set. In conventional frictional weld systems, the physical and metallurgical property differences between the different alloys may result in the formation of brittle intermetallic compounds. Brittle intermetallic compounds, such as, for example, Al₅Fe₂, Al₂Fe, FeAl, Fe₃Al and Al₆Fe, may limit the joint strength between the two work pieces.

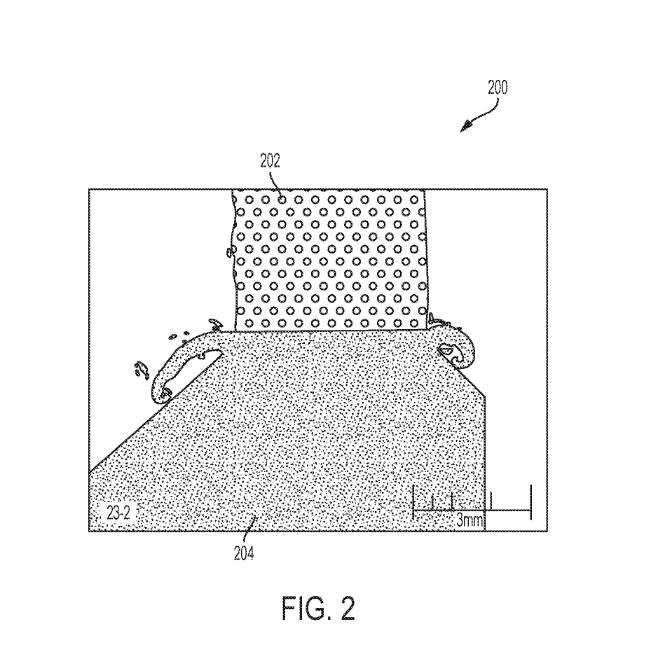

In an exemplary embodiment, a steel component may be coated with a nickel alloy and/or a copper alloy. Then an aluminum component may be spin welded to the coated steel component without the formation of brittle intermetallics at the interface such as, for example, an iron aluminide. FIG. 2 illustrates an interface 200 between a steel component 202 and an aluminum component 204 formed by a friction welding process. As can be seen in FIG. 2, the material at the interface of the aluminum component 204 may be pushed aside or outwardly while the material in the steel component 202 is not deformed. This is due to the difference in characteristics between the steel alloy and the aluminum alloy. In order to maintain the coating at the interface, it is preferable that the steel component 202 include the coating. In this manner, the steel may not deform and may provide a secure foundation to maintain the coating at the interface. In contrast, if the coating were only provided to the aluminum component 204, the deformation of the aluminum material away from the interface may carry at least a portion of coating away from the interface which may reduce the effectiveness of the coating to reduce and/or prevent the formation of brittle intermetallics.

Further, in order to maintain the stability of the coating throughout the solid state welding process, the coating should have a higher melting temperature than the aluminum alloy. In this manner, the coating will be less likely to melt and then move away from the interface between the steel component and the aluminum component, which prevents direct contact between the aluminum and the steel and, therefore, prevents and/or reduced the development of brittle intermetallics. Preferably, only the aluminum alloy may be deformed and/or displaced at the interface.

While the present detailed description describes a friction welding process, it is to be understood that exemplary embodiments of the present disclosure include any solid state welding process, such as, for example, cold welding, diffusion welding, ultrasonic welding, explosion welding, forge welding, friction welding, hot pressure welding, roll welding and the like. Solid state welding joins the base metals without significant melting of the base metals.

Further, while the present detailed description describes and illustrates a steel gear and aluminum clutch shell, it is to be understood that exemplary embodiments of the present disclosure may be applicable to combining two dissimilar alloys to form a single component such that brittle intermetallic compounds are not formed at the interface. Exemplary embodiments of the present disclosure may be useful in providing components for an automobile such as in a vehicle propulsion system,

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for welding a first component to a second component, the method comprising:
providing a first component comprising a first alloy and having coating comprising a second alloy on a face of the first component; and
solid state welding a second component comprising a third alloy to the coating of the first component, wherein the second alloy includes only non-ferrous compounds.

2. The method of claim 1, wherein the first alloy comprises a steel alloy.

3. The method of claim 1, wherein the third alloy comprises an aluminum alloy.

4. The method of claim 1, wherein the third alloy comprises a magnesium alloy.

5. The method of claim 1, wherein the solid state welding comprises friction welding.

6. The method of claim 1, further comprising applying the coating to the first component.

7. The method of claim 6, wherein the step of coating comprises at least one of a plating, hot dipping, vapor deposition, physical vapor deposition, and chemical vapor deposition.

8. The method of claim 1, wherein the second alloy comprises one of a nickel alloy and a copper alloy.

9. The method of claim 1, wherein the thickness of the coating is between about 10 to 100 micrometers.

10. A part for a vehicle propulsion system, the part produced by a process comprising the steps of:
providing a first component comprising a first alloy and having coating comprising a second alloy on a face of the first component; and
solid state welding a second component comprising a third alloy to the coating of the first component, wherein the second alloy includes only non-ferrous compounds.

11. The part of claim 10, wherein the first alloy comprises a steel alloy.

12. The part of claim 10, wherein the third alloy comprises an aluminum alloy.

13. The part of claim 10, wherein the third alloy comprises a magnesium alloy.

14. The part of claim 10, wherein the solid-state welding comprises friction welding.

15. The part of claim 10, further comprising applying the coating to the first component.

16. The part of claim 15, wherein the step of coating comprises at least one of a plating, hot dipping, vapor deposition, physical vapor deposition, and chemical vapor deposition.

17. The part of claim 10, wherein the second alloy comprises one of a nickel based alloy and a copper based alloy.

18. The part of claim 10, wherein the thickness of the coating is between about 10 to 200 micrometers.
